(19) United States
(12) Patent Application Publication
(10) Pub. No.: US 2024/0332923 A1
(43) Pub. Date: Oct. 3, 2024

(54) DESICCANT FOR ALTERNATIVE DIELECTRIC GAS BLENDS IN ELECTRIC SWITCHGEAR

(71) Applicant: S&C Electric Company, Chicago, IL (US)

(72) Inventors: Jeffery Alan Moore, Deer Park, IL (US); Rahul Jain, Evanston, IL (US)

(73) Assignee: S&C Electric Company, Chicago, IL (US)

(21) Appl. No.: 18/438,733

(22) Filed: Feb. 12, 2024

Related U.S. Application Data
(60) Provisional application No. 63/456,099, filed on Mar. 31, 2023.

(51) Int. Cl. H02B 13/055

(52) U.S. Cl. CPC H02B 13/055

(57) ABSTRACT

Switchgear including a sealed tank enclosing electrical components and being filled with a dielectric gas containing CO₂. The tank also encloses an activated alumina desiccant that absorbs a limited amount of the CO₂. In one non-limiting embodiment, the dielectric gas is a blended CO₂—Novec™ 4710 dielectric gas and the activated alumina is in the form of beads enclosed in a bag.

### CROSS-REFERENCE TO RELATED APPLICATION

This application claims the benefit of priority from the U.S. Provisional Application No. 63/456,099, filed on Mar. 31, 2023, the disclosure of which is hereby expressly incorporated herein by reference for all purposes.

### BACKGROUND

### Field

This disclosure relates generally to using activated alumina as a desiccant for electrical equipment enclosed in a dielectric gas containing CO₂.

### Discussion of the Related Art

An electrical power distribution network, often referred to as an electrical grid, typically includes power generation plants each having power generators, such as gas turbines, nuclear reactors, coal-fired generators, hydro-electric dams, etc. The power plants provide power at medium voltages that are then stepped up by transformers to a high voltage AC signal to be connected to high voltage transmission lines that deliver electrical power to substations typically located within a community, where the voltage is stepped down to a medium voltage for distribution. The substations provide the medium voltage power to three-phase feeders including three single-phase feeders that carry the same or similar current but are 120° apart in phase. three-phase and single-phase lateral lines are tapped off of the feeder that provide the medium voltage to various distribution transformers, where the voltage is stepped down to a low voltage and is provided to loads, such as homes, businesses, etc. Some power distribution networks may employ underground single-phase lateral circuits that feed residential and commercial customers. Often times these circuits are configured in a loop and fed from power sources at both ends, where an open circuit location in the loop isolates the two power sources.

Power distribution networks of the type referred to above typically include switching devices, breakers, reclosers, current interrupters, etc. that control the flow of power throughout the network. Standalone pad mounted and underground switchgear including electrical disconnect switches, fuses and/or circuit breakers used to control, protect and isolate electrical equipment are often employed to de-energize equipment to allow work to be done and to clear faults. Switchgear often include load-interrupter switches, resettable, vacuum fault interrupters and other equipment and components that are enclosed in a gas-insulated steel tank to provide electrical isolation. The tank is generally filled with a dielectric gas through a fill port, and the fill port is subsequently sealed with a plug so that the tank is hermetically sealed at the factory. The dielectric gas acts as an insulator having a greater insulating capacity than air so that higher voltages can be tolerated so that the various electrical components in the tank can be spaced closer together without causing arcing therebetween, which allows the switchgear to be smaller. Moisture can collect in the tank from various sources, such as being released from the electrical components therein, which reduces the dielectric capacity of the gas possibly increasing the chance of flash-over or arcing between the components and increases the corrosion potential of the components. Therefore, it is common to include a desiccant in the tank that absorbs moisture, which is typically a polyester bag filled with moisture absorbing beads or pellets.

Often, sulfur hexafluoride (SF₆) is used as the dielectric gas for the sealed tanks in switchgear and zeolite alumino silicate is used as the desiccant. However, SF₆ is a designated a greenhouse gas, which has environmental drawbacks. The industry is therefore moving towards using alternative dielectric gases and gas blends having lower greenhouse emissions for the sealed tanks in switchgear, such as a blend of carbon dioxide (CO₂) and 3M™ Novec™ 4710, CAS #42532-60-5, which is a perfluoroisobutyronitrile. One specific blend that is now being used is 87% CO₂ and 13% Novec™ 4710, which has a 97% reduction in greenhouse emissions over SF₆. However, the commonly used desiccants that work well when SF₆ is the dielectric gas absorb CO₂ because the pore size of these desiccants is usually 3-4 Å and the atomic diameter of CO₂ is 3.3 Å. The absorption of CO₂ from the gas reduces the pressure in the tank, reduces the ability of the desiccant to absorb moisture and reduces the insulating capacity of the dielectric gas over time. Therefore, other desiccants are needed for this purpose that do not significantly absorb CO₂, but absorb the desired amount of moisture.

### SUMMARY

The following discussion discloses and describes switchgear including a sealed tank enclosing electrical components and being filled with a dielectric gas containing CO₂. The tank also encloses an activated alumina desiccant that absorbs a limited amount of the CO₂. In one non-limiting embodiment, the dielectric gas is a blended CO₂—Novec™ 4710 dielectric gas and the activated alumina is in the form of beads enclosed in a bag.

Additional features of the disclosure will become apparent from the following description and appended claims, taken in conjunction with the accompanying drawings.

### BRIEF DESCRIPTION OF THE DRAWINGS

FIG. 1 is an isometric view of medium-voltage switchgear including a hermetically sealed and gas insulated tank;

FIG. 2 is a broken-away isometric view of the tank in the switchgear shown in FIG. 1 illustrating a desiccant bag; and

FIG. 3 is a broken-away view of the desiccant bag separated from the tank including activated alumina beads.

### DETAILED DESCRIPTION OF THE EMBODIMENTS

The following discussion of the embodiments of the disclosure directed to electric switchgear including a sealed tank enclosing electrical components, a dielectric gas containing CO₂ and an activated alumina desiccant is merely exemplary in nature, and is in no way intended to limit the disclosure or its applications or uses. For example, the activated alumina has particular application for use in a hermetically sealed tank in switchgear. However, as will appreciated by those skilled in the art, the activated alumina desiccant may have other applications.

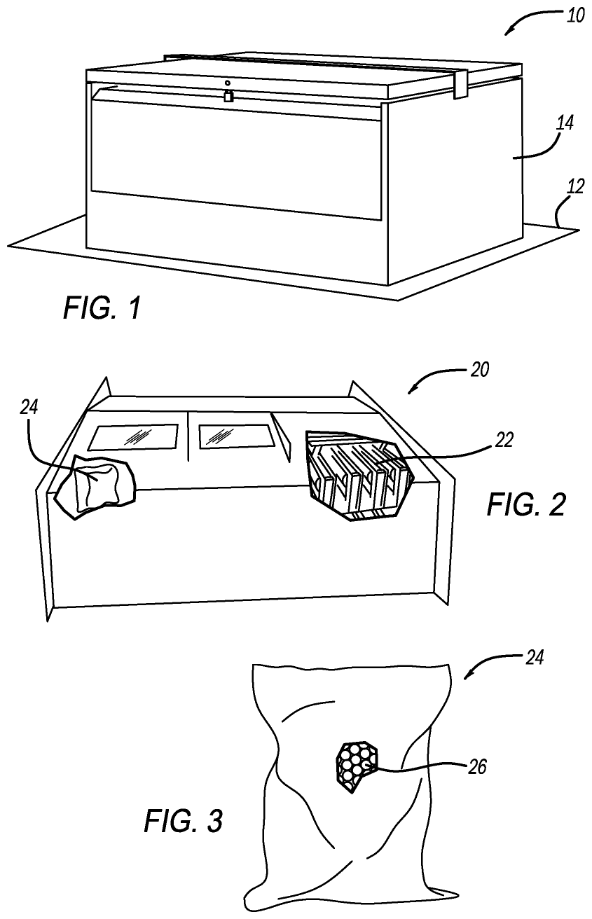

FIG. 1 is an isometric view of medium-voltage switchgear 10 mounted on a pad 12 and including an enclosure 14. The switchgear 10 is intended to represent any suitable switchgear employed in an electrical power distribution network as discussed above, and can include any and all components for a particular application.

FIG. 2 is a broken-away isometric view of a hermetically sealed steel tank 20 that can be used in the switchgear 10 shown in FIG. 1. Typically, vacuum circuit breakers, disconnect switches and/or other components and electrical equipment represented by component 22 associated with the operation of the switchgear 10 is enclosed in the tank 20 to provide the equipment in a gas-insulated environment. The tank 20 is filled with an insulating or dielectric gas, such as the CO₂—Novec™ 4710 gas blend referred to above, through a fill port (not shown) during manufacture of the switchgear 10, and the fill port is sealed with a tamper resistant steel plug (not shown). A polyester fabric desiccant bag 24 is placed in the tank 20 to absorb moisture therein for the reasons discussed above. The bag 24 is filled with an activated alumina desiccant, which is a porous, solid form of aluminum oxide, otherwise known as Al₂O₃ or alumina, and can be in any suitable form, such as powder, beads, pellets, etc. The activated alumina maintains the moisture level in the tank 20 below 400 ppm. The activated alumina only absorbs a small amount of CO₂, and thus works effectively with the CO₂—Novec dielectric gas or other primarily CO₂ based alternative dielectric gases.

FIG. 3 is a broken-away view of the bag 24 separated from the tank 20 and showing activated alumina beads 26 therein. In one non-limiting embodiment, the beads are 3/16″ in diameter. The size of the bag 24 and the volume of the beads 26 is selected to be suitable for the particular switchgear and application.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. Switchgear comprising a sealed tank enclosing electrical components and being filled with a dielectric gas including CO₂, the tank also enclosing an activated alumina desiccant.

2. The switchgear according to claim 1 wherein the activated alumina desiccant is in the form of beads.

3. The switchgear according to claim 2 wherein the beads have a diameter of about 3/16 of an inch.

4. The switchgear according to claim 2 wherein the beads are enclosed in a bag.

5. The switchgear according to claim 4 wherein the bag is a polyester fabric bag.

6. The switchgear according to claim 1 wherein the dielectric gas includes a perfluoroisobutyronitrile.

7. The switchgear according to claim 6 wherein the dielectric gas is a blended CO₂—Novec™ 4710 dielectric gas.

8. The switchgear according to claim 7 wherein the dielectric gas is 87% CO₂ and 13% Novec™ 4710.

9. The switchgear according to claim 1 wherein the electrical components are electrical disconnect switches, fuses and/or circuit breakers.

10. The switchgear according to claim 1 wherein the tank is a steel tank.

11. The switchgear according to claim 1 wherein the switchgear is medium-voltage switchgear.

12. Switchgear comprising a sealed tank enclosing electrical components and being filled with a blended CO₂— Novec™ 4710 dielectric gas, the tank also enclosing activated alumina beads enclosed in a bag.

13. The switchgear according to claim 12 wherein the beads have a diameter of about 3/16 of an inch.

14. The switchgear according to claim 12 wherein the bag is a polyester fabric bag.

15. The switchgear according to claim 12 wherein the dielectric gas is 87% CO₂ and 13% Novec™ 4710.

16. The switchgear according to claim 12 wherein the electrical components are electrical disconnect switches, fuses and/or circuit breakers.

17. The switchgear according to claim 12 wherein the tank is a steel tank.

18. The switchgear according to claim 12 wherein the switchgear is medium-voltage switchgear.

19. Switchgear comprising a sealed tank enclosing electrical components and being filled with a dielectric gas, the tank also enclosing an activated alumina desiccant.

20. The switchgear according to claim 19 wherein the activated alumina desiccant is in the form of beads.
